(19) United States
(12) Patent Application Publication
(10) Pub. No.: US 2008/0034850 A1
(43) Pub. Date: Feb. 14, 2008

(54) Determining The Fuel Consumption Of An Internal Combustion Engine

(75) Inventor: Ing J. Widdershoven, Bg (DE)

Correspondence Address: GIFFORD, KRASS, SPRINKLE,ANDERSON & CITKOWSKI, P.C, PO BOX 7021, TROY, MI, 48007-7021, US

(73) Assignee: FEV MOTORENTECHNIK GMBH, Aachen (DE)

(21) Appl. No.: 11/831,369

(22) Filed: Jul. 31, 2007

(30) Foreign Application Priority Data
Aug. 3, 2006 (DE) 102006036667.0

(51) Int. Cl. G01L 3/26; F16K 49/00; G01F 9/00

(52) U.S. Cl. 73/113; 137/339

(57) ABSTRACT

A method of determining the fuel consumption of an internal combustion engine, more particularly when operated on a test rig, wherein fuel is supplied in a circuit to the internal combustion engine and discharged therefrom and wherein a quantity of fuel is supplied to the circuit via a branch line from a fuel tank and measured in the branch line, wherein the fuel in the circuit is re-cooled in the return line between the internal combustion engine and the entrance of the branch line.

### CROSS-REFERENCE TO RELATED APPLICATIONS

This application claims priority of German Patent Application Serial No. 10 2006 036 667.0, filed Aug. 3, 2006, which is incorporated herein by reference.

### FIELD OF THE INVENTION

The invention relates to a method of and device for determining the fuel consumption of an internal combustion engine, more particularly when operated on a test rig, comprising a closed circuit for the fuel into which the internal combustion engine is incorporated as a consumer, a fuel tank and a branch line extending from the fuel tank to the circuit, as well as a through-flow quantity measuring device in the branch line for measuring the consumption.

### BACKGROUND OF THE INVENTION

Current, accurate fuel consumption measurements are extremely important for modern test rigs for internal combustion engines. It is a fact that fuel consumption is adversely affected by temperature fluctuations in the fuel circuit. Such temperature fluctuations are primarily due to changes in temperature of the internal combustion engine when in stationary operation, whereas they are as a rule negligible during a quasi-stationary type of operation. Such changes in temperature can hardly be avoided although in the forward line of the fuel circuit there are provided devices for conditioning the fuel temperature, more particularly a cooler as well as a heater. The time-related changes in temperature lead to changes in the density of the fuel and thus changes in the fuel volume in the circuit while the volume of the line system remains constant. The fuel quantity which is supplied from a tank and which is recorded at a consumption measuring point in a supply line is reduced if there occurs a temporary increase in temperature due to an increase in the volume of the fuel in the system, whereas if there occurs a reduction in temperature and thus a reduction in volume, an increased quantity has to be supplied through the consumption measuring point, compared to the actual quantity consumed by the internal combustion engine.

### SUMMARY OF THE INVENTION

It is the object of the present invention to ensure improved fuel measurements for internal combustion engines, also during stationary phases of engine operation. The objective is achieved by providing a method according to which the fuel in the circuit is re-cooled in the return line between tie internal combustion engine and entrance of the branch line into the circuit. Re-cooling, more particularly re-cooling to a constant temperature, is applied to that partial volume in the fuel return line between the internal combustion engine and entrance of the branch line which is affected most by changes in temperature and thus by changes in volume, so that the number of errors is reduced. In a first approximation it is assumed that the temperature-related changes in volume in the forward line from the tank to the internal combustion engine and in tie small fuel volume enclosed in the internal combustion engine are negligibly small.

According to a further embodiment it is proposed that the fuel in the circuit behind the connection of the branch line to the circuit is controlled and set to a constant feed temperature.

An inventive device is characterized by a re-cooler for the fuel, which re-cooler is arranged in the return line of the circuit between the internal combustion engine and the entrance of the branch line to the circuit.

This clearly reduces the major source of errors, i.e. the change in the fuel temperature in the circuit directly behind the internal combustion engine in the case of load changes.

More particularly, it is proposed that there is provided a cooling agent controlling device for controlling and setting the fuel to a constant exit temperature TRI at the re-cooler.

As a rule, the inventive device comprises a system for conditioning the fuel temperature in the forward line, which device, more particularly, comprises a fuel cooler and a fuel heating device.

The measuring accuracy can be improved further by using an additional fuel cooler in the return line from the internal combustion engine to the tank.

### BRIEF DESCRIPTION OF THE DRAWING

FIG. 1 is a schematic diagram illustrating an embodiment of the present invention.

### DETAILED DESCRIPTION OF THE PREFERRED EMBODIMENTS

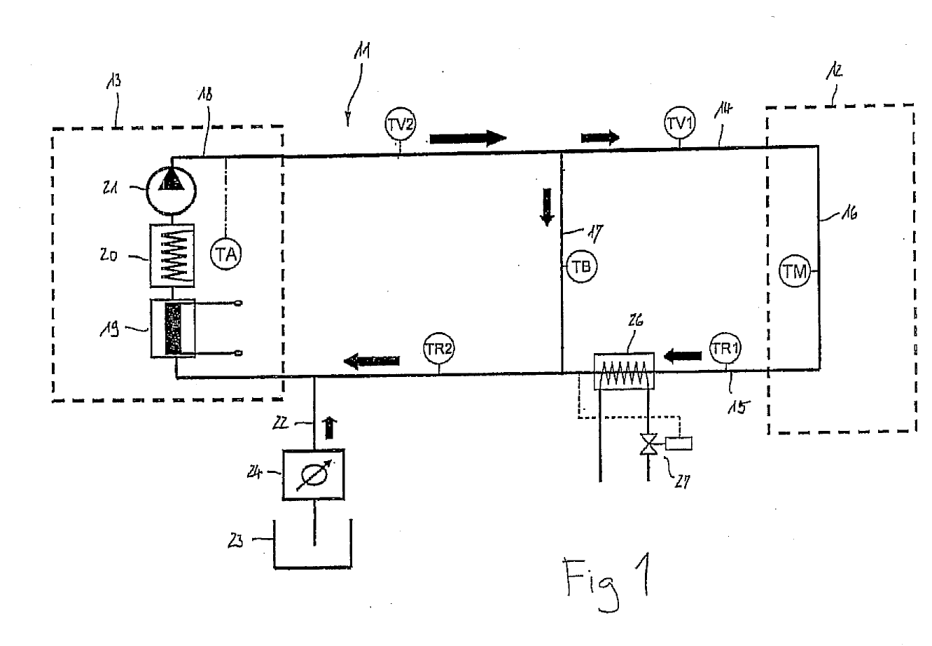

The diagram of an inventive device contained in FIG. 1 will be described below. In a test rig environment there is shown a fuel circuit 11 of an internal combustion engine 12, which fuel circuit 11 forms a closed loop and is guided through the internal combustion engine 12 on the one hand and through a fuel temperature conditioning unit 13 on the other hand. Furthermore, the circuit is shown to comprise a forward branch line 14, a return branch line 15, an engine through-passage 16, a bypass line 17 parallel to the engine through-passage 16 as well as a conditioning portion 18 in the region of the unit 13. As far as details are concerned, the conditioning unit 13 comprises a heater 19, a cooler 20 and a circulation pump 21. The fuel quantity held in circulation by the circulation pump 21 is continuously replenished by the fuel quantity consumed in the engine through-passage 16, via a branch line 22 which is connected to the fuel tank 23 and the circuit 11. In the branch line 22 there is provided a consumption measuring point 24 which records an apparent consumption inS which corresponds to the quantity actually supplied to the circuit 11 via the branch line 22. As a result of temperature changes of the stationary type, more particularly in the region of the engine through-passage 16 in the case of load increases or load reductions of the internal combustion engine, there takes place a change in the density of the fuel, so that if the temperature is increased in the engine through-passage 16 and in the return line 15, an increased volume flow returns, thus falsely pretending that tie fuel consumption of the internal combustion engine 12 is lower, whereas if the temperature in the engine through-passage 16 and in the return line 15 is reduced, the returning volume flow is reduced, thus pretending that there exists an increased fuel consumption as compared to tie true fuel consumption of the internal combustion engine. To reduce the error, the return line 15 comprises a re-cooler 26 in whose cooling agent circuit there is provided a controlling device 27 by means of which die temperature TR1 at the entrance to the re-cooler 26 which greatly changes under stationary operational conditions is re-cooled to a constant value TR2 at the exit of die re-cooler 26, so that the causes of errors remain limited to the region of the engine through-passage 16 and to a small part of the return line.

The foregoing drawings, discussion and description are illustrative of specific embodiments of the present invention, but they are not meant to be limitations upon the practice thereof. Numerous modifications and variations of the invention will be readily apparent to those of skill in the art in view of the teaching presented herein. It is the following claims, including all equivalents, which define the scope of the invention.

I claim:

1. A method of determining a fuel consumption of an internal combustion engine, wherein fuel is supplied to the internal combustion engine and discharged therefrom in a circuit and wherein a quantity of fuel is supplied to the circuit via a branch line from a fuel tank and measured in the branch line,
wherein the fuel is re-cooled in a return line, the return line located in the circuit between the internal combustion engine and the branch line.

2. A method according to claim 1, wherein the fuel in the return line is re-cooled to a constant temperature.

3. A method according to claim 1, wherein the fuel in the circuit past the connection of the branch line is controlled and set to a constant feed temperature.

4. A device for determining a fuel consumption of an internal combustion engine, said device comprising:
a closed circuit for fuel, said closed circuit having the internal combustion engine in the form of a consumer;
a fuel tank and a branch line extending from said fuel tank to said closed circuit;
a through-flow quantity measuring device in said branch line for measuring the fuel consumption; and
a re-cooler for said fuel, said re-cooler arranged in a return line of said closed circuit between the internal combustion engine and an entrance of said branch line into said closed circuit.

5. A device according to claim 4, further comprising a cooling agent line in said re-cooler and a cooling agent controlling device for setting said fuel to a constant exit temperature at said re-cooler.

6. A device according to claim 4, wherein a fuel cooler is arranged in said closed circuit past said entrance of said branch line into said closed circuit.

7. A device according to claim 6, wherein a fuel heater is arranged in said closed circuit past said entrance of said branch line into said closed circuit.

8. A device according to claim 5, wherein a second fuel cooler is arranged in said closed circuit between the internal combustion engine and said entrance of said branch line into said closed circuit.
